(19) United States
(12) Patent Application Publication
(10) Pub. No.: US 2015/0161979 A1
(43) Pub. Date: Jun. 11, 2015

(54) HANDHELD ELECTRONIC APPARATUS AND CORRESPONDING NOISE-CANCELING HEADPHONES

(71) Applicant: MERRY ELECTRONICS (SHENZHEN) CO., LTD., Shenzhen (CN)

(72) Inventors: HUNG-YUAN LI, New Taipei City (TW); YA-KE LAN, New Taipei City (TW); CHIA-HSIN HUNG, New Taipei City (TW)

(73) Assignee: MERRY ELECTRONICS (SHENZHEN) CO., LTD., Shenzhen (CN)

(21) Appl. No.: 14/101,513

(22) Filed: Dec. 10, 2013

(51) Int. Cl. G10K 11/175

(52) U.S. Cl. CPC G10K 11/175

(57) ABSTRACT

A handheld electronic apparatus including a connecting interface, a switching circuit and a control circuit is provided. A corresponding noise-canceling headphone including a connecting interface, a microphone, two speakers and a noise-canceling circuit is also provided. When a headphone is electrically connected to the handheld electronic apparatus and the control circuit determines that the headphone is the noise-canceling headphone, then the control circuit provides an working voltage to the noise-canceling headphone through different circuit paths by controlling the switching circuit.

### FIELD OF THE INVENTION

The present invention relates to a structure of handheld electronic apparatus and a corresponding noise-canceling headphone, and more particularly to a handheld electronic apparatus suitable for providing an operating voltage to a noise-canceling circuit of a noise-canceling headphone, wherein the noise-canceling headphone do not need to use any of batteries.

### BACKGROUND OF THE INVENTION

An active noise-controlling technology has being provided in 1936 AD, a principle thereof is by using the acoustic interference to manufacture a moderate anti-noise, and using a destructive interference of the anti-noise to interfere noise to make a sum of sound waves of a sound field reach zero and achieve a purpose of reducing noise. In addition, a meaning of the “active” control is named to be distinguished from a traditional “passive” noise-control. The passive noise-control methods including an isolation treatment, a damping treatment, a sound-absorbing treatment, or installing muffler, is effective in processing median-frequency or high-frequency noise, but is less effective in handling low-frequency noise such as earplugs or soundproof windows. The active noise-control technology is a professional technology combined with sound engineering technologies, electronic circuit technologies, digital signal processor and control theory. As in recent years, advances in relative technologies as well as optimization in digital signal processors and low price thereof make the active noise-control technologies be implemented as well as in mass production. And now, corresponding headphones are in real production and in mass production. For example, the active noise-control headphone is applied to be configured in a helmet of a fighter pilot to reduce noise generated from an aircraft engine and vibration and increase communication clarity. The principle is to embed microphone in the headphone to detect noise signals, and anti-noise signals is produced by a feedback control and sent to headphone speakers.

Today's technologies can integrate and reduce an active noise-control unit of the noise-canceling headphone having the active noise-control function to make the noise-canceling headphone easy to be carried. But the active noise-control unit still needs some power to be driven. Therefore, most noise-canceling headphones having active noise-control function are electrically connected with an external power supply or a battery suitable for supplying power. But in this way, the noise-canceling headphones become more cumbersome, and are in need of extra charging as well as unable used for a long time.

In view of the aforementioned reasons, there is a need to simplify a power output mode and an audio output mode of the noise-canceling headphone to match specifications of specific devices such as mobile devices.

### SUMMARY OF THE INVENTION

The present invention provides a handheld electronic apparatus electrically connected to a noise-canceling headphone. The handheld electronic apparatus includes a connecting interface, a first switch circuit, a second switch circuit and a control circuit. The connecting interface includes a first pin, a second pin and a third pin, wherein the first pin is suitable for transmitting a microphone signal, the second pin is suitable for transmitting a left channel signal. The first switch circuit is electrically connected between the first pin and the control circuit. The second switch circuit is electrically connected between the second pin and the control circuit. The control circuit electrically connected to the third pin is suitable for determining whether a headphone is electrically connected to the connecting interface in accordance with a voltage change of the third pin. When the headphone is determined as a noise-canceling headphone by the control circuit, then a noise-canceling function of the noise-canceling headphone is opened by the handheld electronic apparatus, and a working voltage provided by the control circuit is transmitted to the first pin through the first switch circuit to serve as a power for operating the noise-canceling circuit of the noise-canceling headphone, however when the noise-canceling headphone is in using a microphone, then the working voltage provided by the control circuit is transmitted to the second pin through the second switch circuit to make the microphone and the noise-canceling function could function at the same time.

The present invention provides a noise-canceling headphone electrically connected to a handheld electronic apparatus, wherein the noise-canceling headphone includes a connecting interface, a first switch circuit, a second switch circuit, a microphone, a left speaker, a right speaker, and a noise-canceling circuit. The connecting interface electrically connected to the handheld electronic apparatus has a first pin, a second pin and third pin. The first pin is suitable for receiving a microphone signal. The second pin is suitable for receiving a left channel signal. The first switch circuit electrically connected between the first pin and the noise-canceling circuit is suitable for determining whether a signal could pass through in accordance with a magnitude of a passing voltage. The second switch circuit electrically connected between the second pin and the noise-canceling circuit is suitable for determining whether a signal could pass through in accordance with a magnitude of a passing voltage. The microphone is electrically connected to the first pin. The left speaker is electrically connected to the second pin. The right speaker is electrically connected to the third pin. The noise-canceling circuit is electrically connected between the first switch circuit and the second switch circuit to receive the working voltage through the first switch circuit and the second switch circuit.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is schematic functional block diagrams illustrating a handheld electronic apparatus electronically connected to a noise-canceling headphone in accordance with an embodiment of the present invention;

FIG. 2 is a detailed functional block diagram illustrating the handheld electronic apparatus in accordance with another embodiment of the present invention;

FIG. 3 is a schematic functional block diagram illustrating the handheld electronic apparatus in accordance with another embodiment of the present invention;

FIG. 4 is a schematic functional block diagram illustrating a control circuit in accordance with another embodiment of the present invention;

FIG. 5 is a detailed functional block diagram illustrating the handheld electronic apparatus in accordance with another embodiment of the present invention;

FIG. 6 is a schematic functional block diagram illustrating a noise-canceling headphone in accordance with another embodiment of the present invention;

FIG. 7 is a schematic functional block diagram illustrating a noise-canceling headphone in accordance with another embodiment of the present invention;

FIG. 8 is a schematic flow diagram illustrating steps of a power management method in accordance with another embodiment of the present invention;

FIG. 9A-9B is a schematic flow diagram illustrating steps of a power management method adapted to be applied between a handheld electronic apparatus and a headphone in accordance with another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

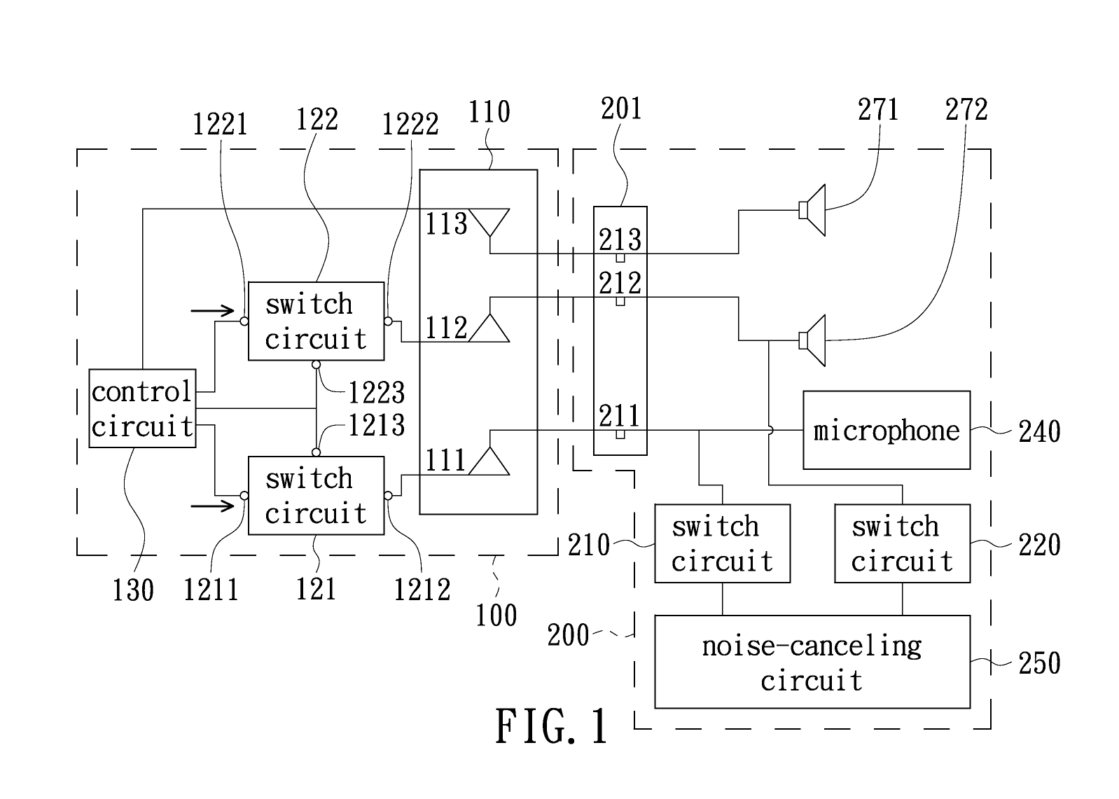

FIG. 1 is schematic functional block diagrams illustrating a handheld electronic apparatus 100 electronically connected to a noise-canceling headphone 200 in accordance with an embodiment of the present invention. Please refer to FIG. 1. The handheld electronic apparatus 100 includes a connecting interface 110, switch circuits 121, 122 and a control circuit 130. The switch circuit 121 includes an input terminal 1211, an output terminal 1212 and a control terminal 1213. The switch circuit 122 includes an input terminal 1221, an output terminal 1222 and a control terminal 1223. The connecting interface 110 includes a first pin 111, a second pin 112, and a third pin 113. The first pin 111 is suitable for transmitting a working voltage received from the output terminal 121 of the switch circuit 121 to a noise-canceling circuit 250 of the noise-canceling headphone 200. The second pin 112 is suitable for transmitting a work voltage received from the output terminal 1222 of the switch circuit 122 to the noise-canceling circuit 250 of the noise-canceling headphone 200. The third pin 113 is electrically connected to the control circuit 130, wherein the control circuit 130 is suitable for sensing a voltage variation of the third pin 113 to detect whether a headphone is inserted or not. In addition, the control circuit 130 is also suitable for providing a working voltage to the input terminal 1211 of the switch circuit 121 and to the input 1221 of the switch circuit 122, as well as providing a first control signal C1 (not shown in FIG. 1) to the control terminal 1213 of the switch circuit 121 and the control terminal 1223 of the switch circuit 122 to control the switch circuits 121, 122. After the noise-canceling headphone electrically connected to the handheld electronic apparatus, then a working voltage is transmitted to the noise-canceling circuit 250 of the noise-canceling headphone 200 through the switch circuit 121; however, if in another working condition such as the noise-canceling headphone 200 is in using a microphone, then the the working voltage is transmitted to the noise-canceling circuit 250 of the noise-canceling headphone 200 through the switch circuit 122.

The noise-canceling headphone 200 includes a connecting interface 201, switch circuits 210, 220, a right speaker 271, a left speaker 272, a microphone 240, and a noise-canceling circuit 250. The connecting interface 201 including pins 211, 212, 213 respectively electrically connected to the first pin 111, the second pin 112 and the third pin 113. The right speaker 271 is electrically connected to the pin 213, the left speaker 272 is electrically connected to the pin 212, and the microphone 240 is electrically connected to the pin 211. The noise-canceling circuit 250 is electrically connected to the pin 211 and the pin 212 to receive the working voltage. It should be noted that the working voltage used for driving the noise-canceling circuit of the noise-canceling headphone could be transmitted in different paths by controlling different switch circuits. The switch circuit 121 and the switch circuit 122 also couldn be replaced with other switch circuits having the same function or other components, but the design of the two switch circuits should not be limited and narrow the invention scope.

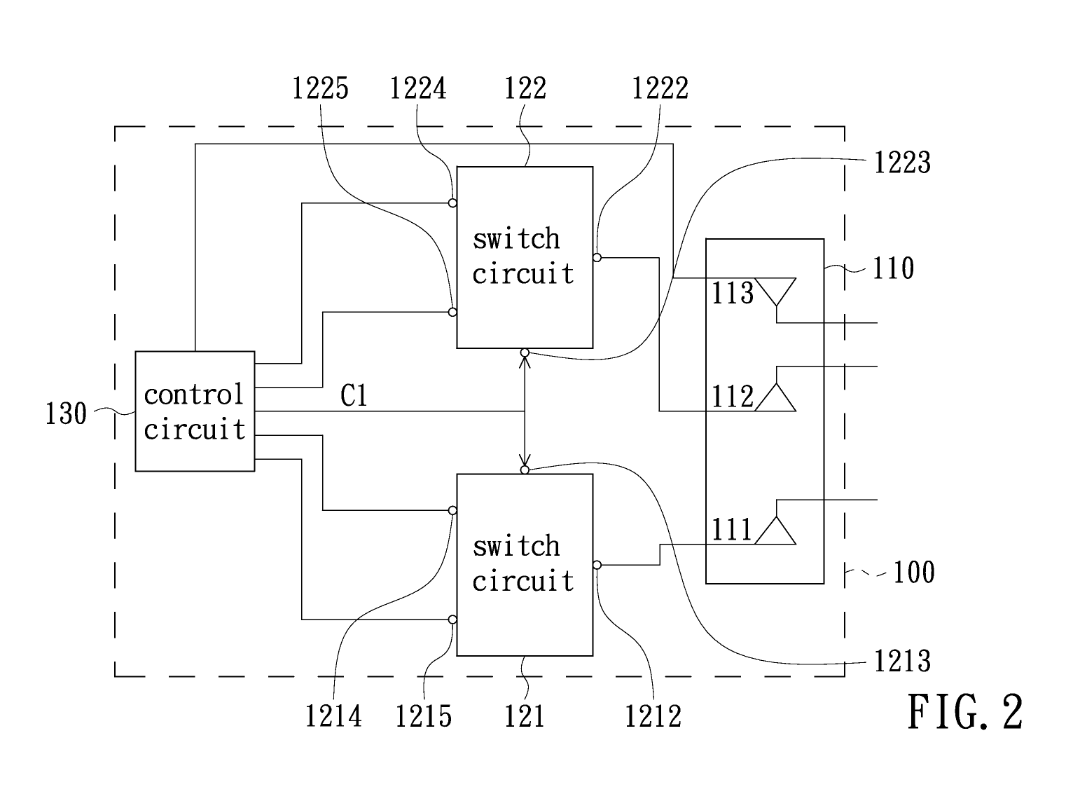

FIG. 2 is a detailed functional block diagram illustrating the handheld electronic apparatus 100 shown in FIG. 1 in accordance with another embodiment of the present invention. The switch circuit 121 includes a first input terminal 1214, a second input terminal 1215, a control terminal 1213, and an output terminal 1212. The switch circuit 122 included a first input terminal 1224, a second input terminal 1225, a control terminal 1223, and an output terminal 1222. The control circuit 130 respectively provides a left channel signal, the working voltage, and the first control signal C1 to the first input terminal 1224, the second input terminal 1225, and the control terminal 1223 of the switch circuit 122, as well as respectively provides the working voltage, a microphone working voltage, and the first control signal C1 to the first input terminal 1214, the second input terminal 1215, and the control terminal 1213 of the switch circuit 121. After connecting to the noise-canceling headphone 200, the output terminal 1212 of the switch circuit 121 is controlled by the control circuit 130 to transmit the working voltage to the first pin 111, as well as the output terminal 1222 of the switch circuit 122 is controlled by the control circuit 130 to transmit the left channel signal to the second pin 112. And when the noise-canceling headphone is in using a microphone, the output terminal 1212 of the switch circuit 121 is controlled by the control circuit 130 to transmit the microphone working voltage to the first pin 111, as well as the output terminal 1222 of the switch circuit 122 is controlled by the control circuit 130 to transmit a working voltage to the second pin 112. The aforementioned control circuit could control two switch circuits by the same control signal, so as to make the two switch circuits transmit different signals in different working conditions. So the two switch circuits can be deemed as a single switch circuit controlled by a single control signal to transmit an output signal.

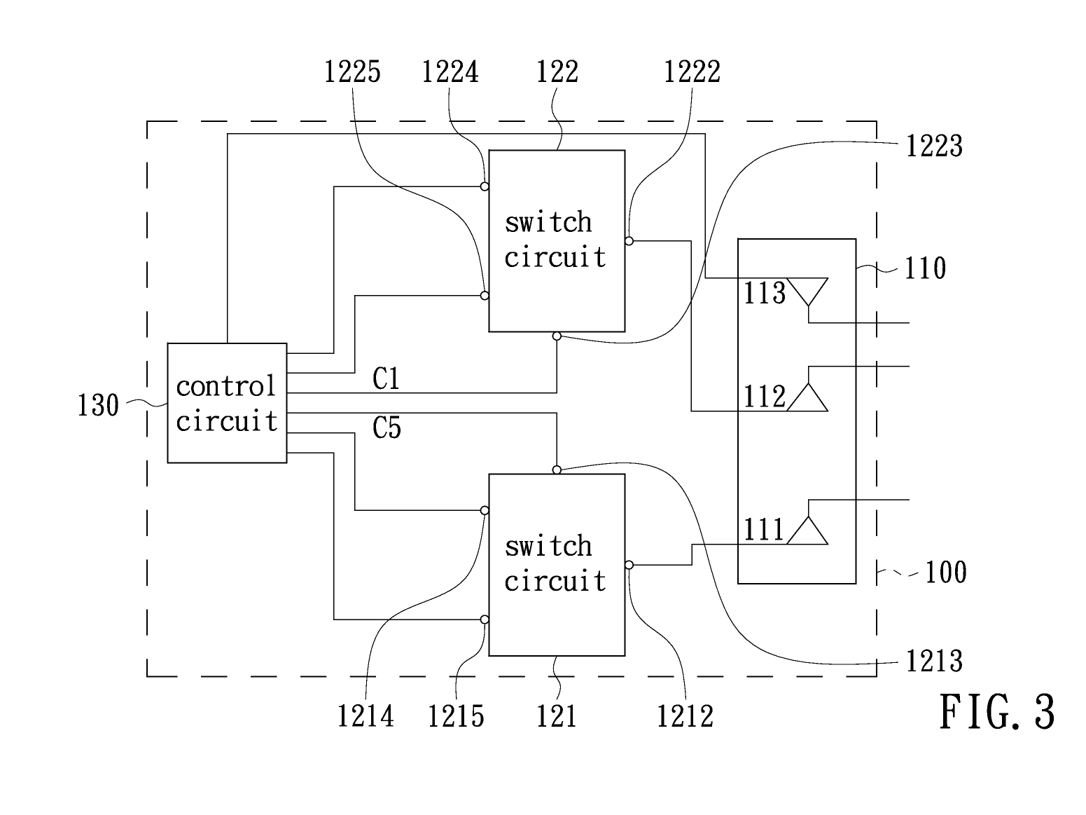

FIG. 3 is a schematic functional block diagram illustrating the handheld electronic apparatus in accordance with another embodiment of the present invention. Compared to the handheld electronic apparatus 100 shown in FIG. 2, the control circuit 130 of the handheld electronic apparatus shown in FIG. 3 respectively provides a left channel signal, the working voltage, and the first control signal C1 to the first input terminal 1224, the second input terminal 1225, and the control terminal 1223 of the switch circuit 122, as well as respectively provides the working voltage, a microphone working voltage, and the fifth control signal C5 to the first input terminal 1214, the second input terminal 1215, and the control terminal 1213 of the switch circuit 121. After the handheld electronic apparatus is electrically connected to the noise-canceling headphone 200, the output terminal 1212 of the switch circuit 121 is controlled by the control circuit 130 to transmit the working voltage to the first pin 111, and the output terminal 1222 of the switch circuit 122 is controlled by the control circuit 130 to transmit the left channel signal to the second pin 112. And when the noise-canceling headphone is in using the microphone, the output terminal 1212 of the switch circuit 121 is controlled by the control circuit 130 to transmit the microphone working voltage to the first pin 111, as well as the output terminal 1222 of the switch circuit 122 is controlled by the control circuit 130 to stop transmitting the left channel signal, and begin transmitting the working voltage to the second pin 112 after a delay time. In this embodiment, a main purpose is to provide a method for avoiding a power failure situation to generate a “POP” sound, such as a method of delaying a delay time, so as to achieve a purpose of eliminating the “POP” sound.

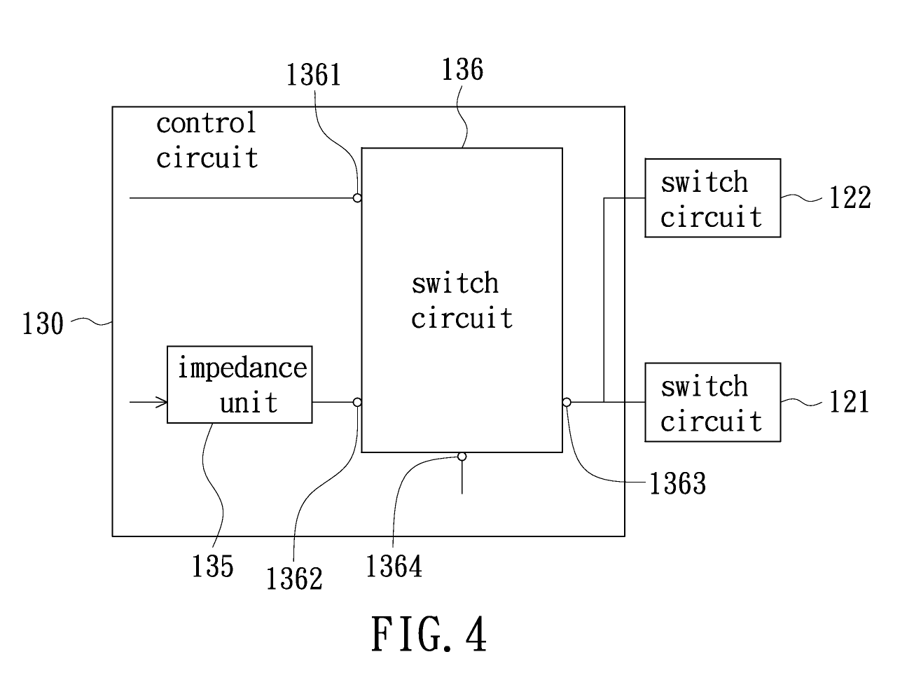

FIG. 4 is a schematic functional block diagram illustrating a control circuit 130 in accordance with an embodiment of the present invention. The control circuit 130 includes an impedance unit 135 and a switch circuit 136, wherein the switch circuit 136 includes a first input terminal 1361, a second input terminal 1362, a control terminal 1364 and an output terminal 1363. When detecting the headphone is electrically connected to the handheld electronic apparatus, the control circuit 130 transmits a detection signal to the second input terminal 1362 of the switch circuit 136 through the impedance unit 135, and provides a second control signal C2 (not shown in FIG. 4) to the control terminal 1364 of the switch circuit 136 to control the output terminal 1363 of the switch circuit 136 to transmit the detection signal received by the second input terminal 1362 to the switch circuits 121, 122. Moreover, by detecting and calculating a voltage drop ratio of the detection signal across the impedance unit 135 and the headphone, the control circuit 130 could judge whether the headphone's type is a normal headphone or a noise-canceling headphone having a microphone. If the headphone's type is the noise-canceling headphone 200, then the control circuit 130 transmits the working voltage to the first input terminal 1361 of the switch circuit 136, and provides the second control signal C2 (not shown in FIG. 4) to the control terminal 1364 of the switch circuit 136 to control the output terminal 1363 of the switch circuit 136 to transmit the working voltage received by the first input terminal 1361 to the switch circuits 121, 122. In this embodiment, a main purpose is to illustrate a judging method including sensing a known signal flowing through a known component and a unknown component to obtain a voltage drop ratio therebetween to learn a possible load of the unknown component to judge whether the type of headphone is. However, for the embodiments of the present invention, it is not limited by the impedance unit to determine whether a type of the known component is and the known component is also not limited to be disposed in the control circuit.

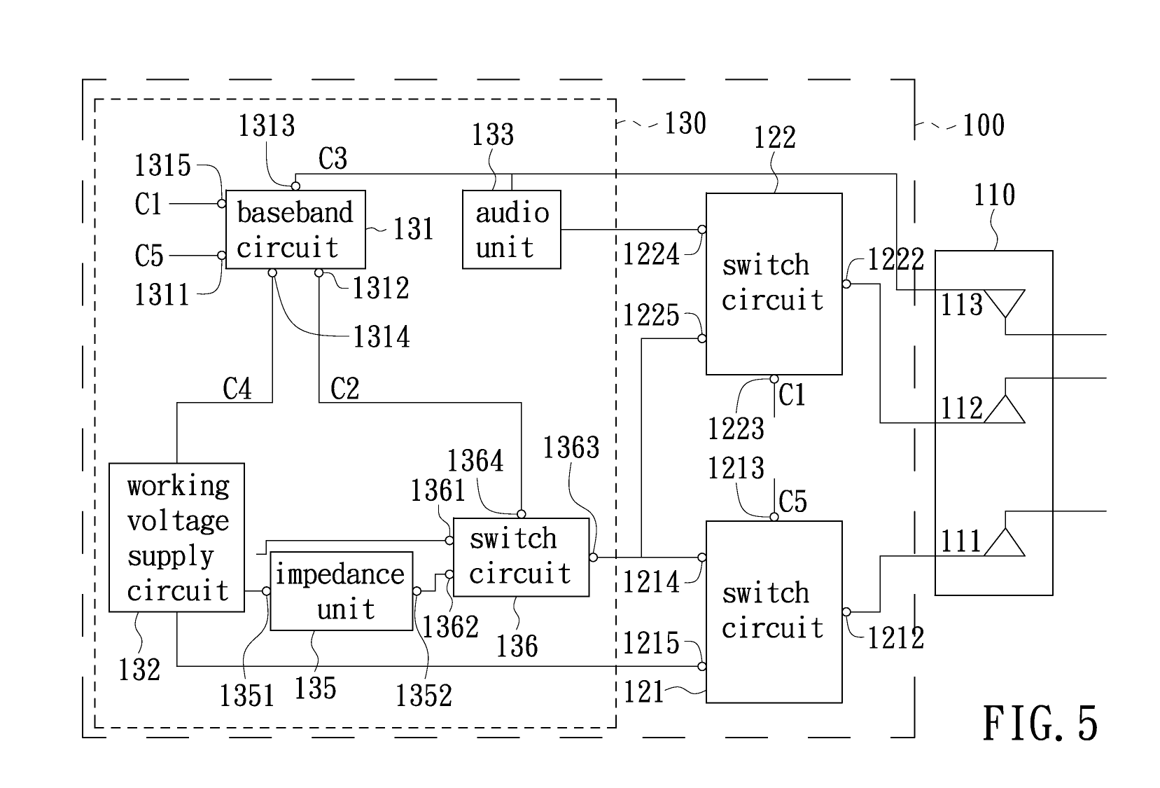

FIG. 5 is a detailed functional block diagram illustrating the handheld electronic apparatus of FIG. 1 in accordance with another embodiment of the present invention. The control circuit 130 of the handheld electronic apparatus 100 includes a baseband circuit 131, a working voltage supply circuit 132, an audio unit 133, the impedance unit 135, and the switch circuit 136. The impedance unit 135 includes an input terminal 1351 and an output terminal 1352, wherein a detection signal provided by the working voltage supply circuit 132 is received by the input terminal 1351 and outputted by the output terminal 1352. The switch circuit 136 includes the first input terminal 1361, the second input terminal 1362, the control terminal 1364, and the output terminal 1363. The first input terminal 1361 is suitable for receiving a working voltage provided by the working voltage supply circuit 132. The second input terminal 1362 is suitable for receiving the detection signal provided by the impedance unit 135. The output terminal 1363 is suitable for outputting the working voltage or the detection signal. The control terminal 1364 is suitable for receiving the second control signal C2 provided by the baseband circuit 131 and determining whether the output terminal 1363 output the working voltage or the detection signal. The baseband circuit 131 includes a first output terminal 1311, a second output terminal 1312, a third output terminal 1313, a forth output terminal 1314, and a fifth output terminal 1315. The first output terminal 1311 outputs the fifth control signal C5 to the control terminal 1213 of the switch circuit 121. The fifth output terminal 1315 outputs the first control signal C1 to the control terminal 1223 of the switch circuit 122. The second output terminal 1312 outputs the second control signal C2 to the control terminal 1364 of the switch circuit 136. The third output terminal 1313 outputs a headphone connecting detection signal C3 to the third pin 113. The forth output terminal 1314 outputs a control signal C4 to the working voltage supply circuit 132.

In this embodiment, according to the headphone connecting detection signal C3 of the third pin 113, the baseband circuit 131 judges whether the headphone is electrically connected to the connecting interface 110 or not. When confirming the link between the headphone and the connecting interface 110, the baseband circuit 131 transmits the fifth control signal C5 to the switch circuit 121 as well as transmits the first control signal C1 to the switch circuit 122 to control the switch circuit 121 to transmit the detection signal received from the switch circuit 136 to the first pin 111; and the baseband circuit 131 transmits the second control signal C2 to the switch circuit 136 to control the switch circuit 136 to transmit the detection signal provided by the impedance unit 135 as well as transmits the forth control signal C4 to the working voltage supply circuit 132 to control the working voltage supply circuit 132 to start transmitting the detection signal to the impedance unit 135, and detects the voltage drop ratio of the impedance unit 135 and the headphone to judge whether a type of the headphone is.

When the headphone has judged as the noise-canceling headphone, then the audio unit 133 transmits the right channel signal to the third pin 113, and the baseband circuit 131 includes transmitting the first control signal C1 to the switch circuit 122 and controlling the switch circuit 122 to transmit the left channel signal provided by the audio unit 133 to the second pin 112; transmitting the second control signal C2 to the switch circuit 136 and controlling the switch circuit 136 to transmit the working voltage provided by the working voltage supply circuit 132 to the switch 121; transmitting the forth control signal C4 to the working voltage supply circuit 132 and controlling the working voltage supply circuit 132 to start transmitting the working voltage; transmitting the fifth control signal C5 to the switch circuit 121 and controlling the switch circuit 121 to transmit the working voltage provided by the working voltage supply circuit 132 to the first pin 111.

When a working condition is meeting, the audio unit 133 transmits the right channel signal to the third pin 113, and the baseband circuit 131 includes transmitting the fifth control signal C5 to the switch circuit 121 and transmitting the first control signal C1 to the switch circuit 122 to control the switch circuit 121 to transmit the microphone working voltage provided by the working voltage supply circuit 132 to the first pin 111 and control the switch circuit 122 to transmit the working voltage provided by the switch circuit 136 to the second pin 112; transmitting the second control signal C2 to the switch circuit 136 and controlling the switch circuit 136 to transmit the working voltage provided by the working voltage supply circuit 132 to the switch circuit 122; and transmitting the forth control signal C4 to the working voltage supply circuit 132 and controlling the working voltage supply circuit 132 to start to transmit the working voltage. The aforementioned detail internal block diagram of the control circuit 130 and the interaction among the switch 121, 122 and the connecting interface 110 are illustrated in this embodiment.

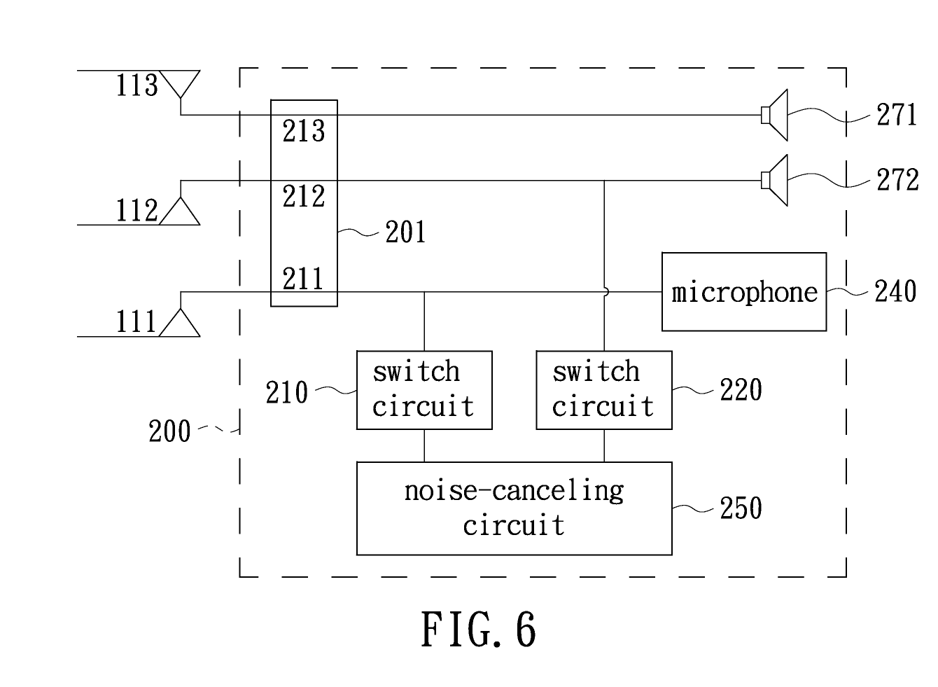

FIG. 6 is a schematic functional block diagram illustrating a noise-canceling headphone in accordance with another embodiment of the present invention. The noise-canceling headphone 200 shown in FIG. 6 includes the connecting interface 201, the switch circuits 210, 220, the microphone 240, the noise-canceling circuit 250, the right speaker 271, and the left speaker 272. The connecting interface 201 includes the pins 211, 212, 213 respectively electrically connected to the first pin 11, the second pin 112, and the third pin 113. The switch circuit 210 is electrically connected between the pin 211 and the noise-canceling circuit 250. The switch circuit 220 is electrically connected between the pin 212 and the noise-canceling circuit 250. The switch circuit 210 is suitable for receiving the working voltage transmitted from the pin 211 and transmitting the same to the noise-canceling circuit 250. The switch circuit 220 is suitable for receiving the working voltage transmitted from the pin 212 and transmitting the same to the noise-canceling circuit 250. In this embodiment, the noise-canceling circuit 250 of the noise-canceling headphone 200 could receive the working voltage from two different paths such as the path suitable for transmitting a signal to the microphone 240 or the path suitable for transmitting an audio signal to the left speaker 272, but not be limited in the present invention.

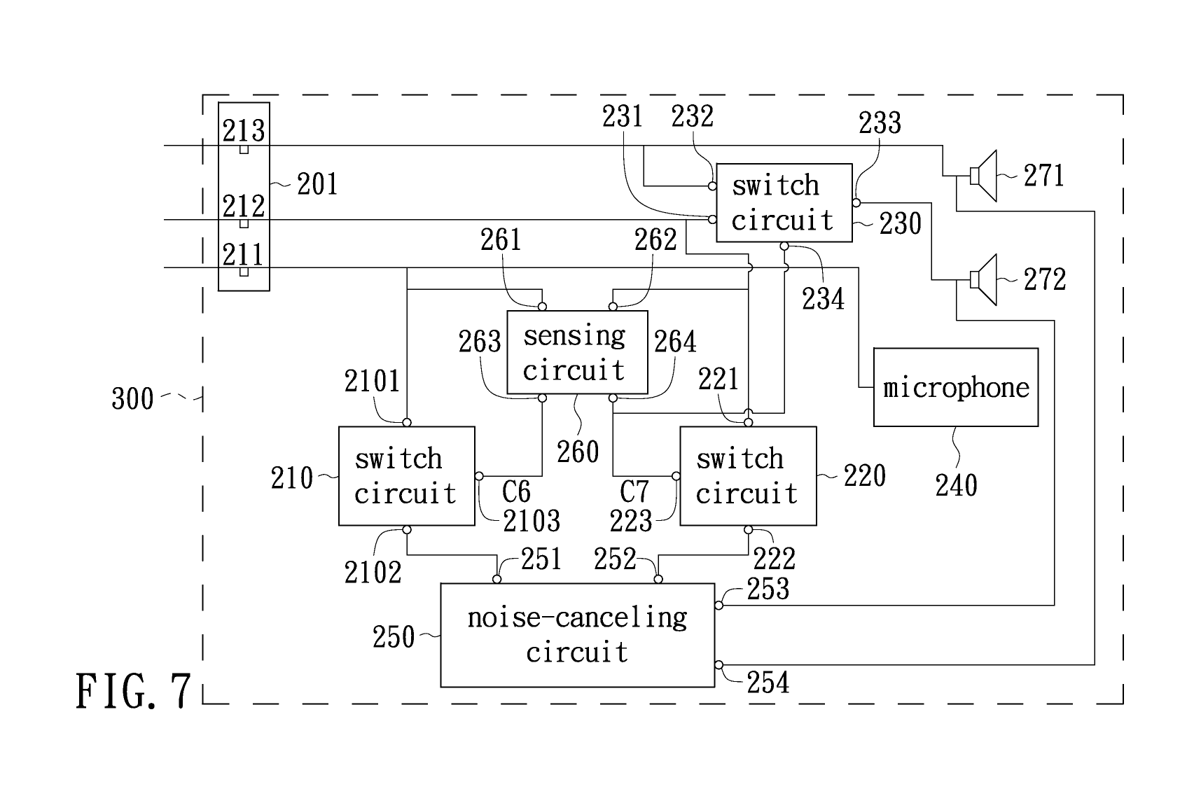

FIG. 7 is a schematic functional block diagram illustrating a noise-canceling headphone in accordance with another embodiment of the present invention. The noise-canceling headphone 300 shown in FIG. 7 includes the connecting interface 201, the switch circuits 210, 220, 230, and the microphone 240, the noise-canceling circuit 250, a sensing circuit 260, the right speaker 271 and the left speaker 272.

The switch circuit 210 includes an input terminal 2101, an output terminal 2102 and a control terminal 2103, wherein the input terminal 2101 is electrically connected to the pin 211, the output terminal 2102 is electrically connected to the noise-canceling circuit 250, and the control terminal 2103 is electrically connected to the sensing circuit 260. The switch circuit 220 includes an input terminal 221 electrically connected to the pin 212, an output terminal 222 electrically connected to the noise-canceling circuit 250, and a control terminal 223 electrically connected to the sensing circuit 260. The switch circuit 230 includes a first input terminal 231 electrically connected to the pin 212, a second input terminal 232 electrically connected to the pin 213, an output terminal 233 electrically connected to the left speaker 272, and a control terminal 234 electrically connected to the second output terminal 264.

In addition, the noise-canceling circuit 250 includes a first input terminal 251, a second input terminal 252, a first output terminal 253, and a second output terminal 254. The first input terminal 251 is suitable for receiving the working voltage provided by the switch circuit 210. The second input terminal 252 is suitable for received the working voltage provided by the switch circuit 220. The first output terminal 253 is suitable for outputting a first noise-canceling signal to the left speaker 272. The second output terminal 254 is suitable for outputting a second noise-canceling signal to the right speaker 271.

Furthermore, the sensing circuit 260 includes a first input terminal 261, a second input terminal 262, a first output terminal 263, and a second output terminal 264. The first input terminal 261 and the second input terminal 262 are respectively electrically connected to the pin 211, 212. The first output terminal 263 is electrically connected to the control terminal 2103 of the switch circuit 210, so as to control whether the switch circuit 210 is to provide the working voltage to the noise-canceling circuit 250 or not. The second output terminal 264 is electrically connected to the control terminal 223 of the switch circuit 220, so as to control whether the switch circuit 220 is to provide the working voltage to the noise-canceling circuit 250 or not.

It is worth mentioning that the noise-canceling circuit 250 further includes, for example, a noise-sensing unit (not shown in FIG. 7) suitable for collecting environmental noise. The noise-sensing unit could be disposed at different positions or combined with other components to achieve an effect of collecting the environmental noise. For example, the noise-sensing unit may be disposed close to the headphone, or disposed in the noise-canceling circuit to collect the environmental noise. Or the microphone may be acting as the noise-sensing unit to collect the environmental noise, but the configuration should not be limited and narrow the invention scope.

As mentioned previously, if the first input terminal 261 of the sensing circuit 260 receives/doesn't receive the working voltage from the pin 211, then the first output terminal 263 outputs a sixth control signal C6 to the control terminal 2103 of the switch circuit 210 to control the switch circuit 210 to start/stop transmitting the working voltage from the pin 211 to the noise-canceling circuit 250. If the second input terminal 262 of the sensing circuit 260 receives/doesn't receive the working voltage from the pin 212, then the second output terminal 264 outputs a seventh control signal C7 to the control terminal 223 of the switch circuit 220 to control the switch circuit 220 to start/stop transmitting the working voltage from the pin 212 to the noise-canceling circuit 250.

Furthermore, the control terminal 234 of the switch circuit 230 is suitable for receiving the seventh control signal C7 outputted from the second output terminal 264 of the sensing circuit 260. When the switch circuit 220 is controlled to start transmitting the working voltage, the seventh control signal C7 simultaneously controls the switch circuit 230 to transmit the right channel signal from the pin 213 to the left speaker 272. However, when the switch circuit 220 is controlled to stop transmitting the working voltage, then the seventh control signal C7 controls the switch circuit 230 to transmit the left channel signal from the pin 212 to the left speaker 272. Therefore, the signal received by the sensing circuit may be used for controlling whether the switch circuit transmits the signal to the noise-canceling or not. For a phone call, the left channel signal and the right channel signal may be integrated to the left channel or the right channel, then the left channel or the right channel is free to transmit other signal to the noise-canceling circuit.

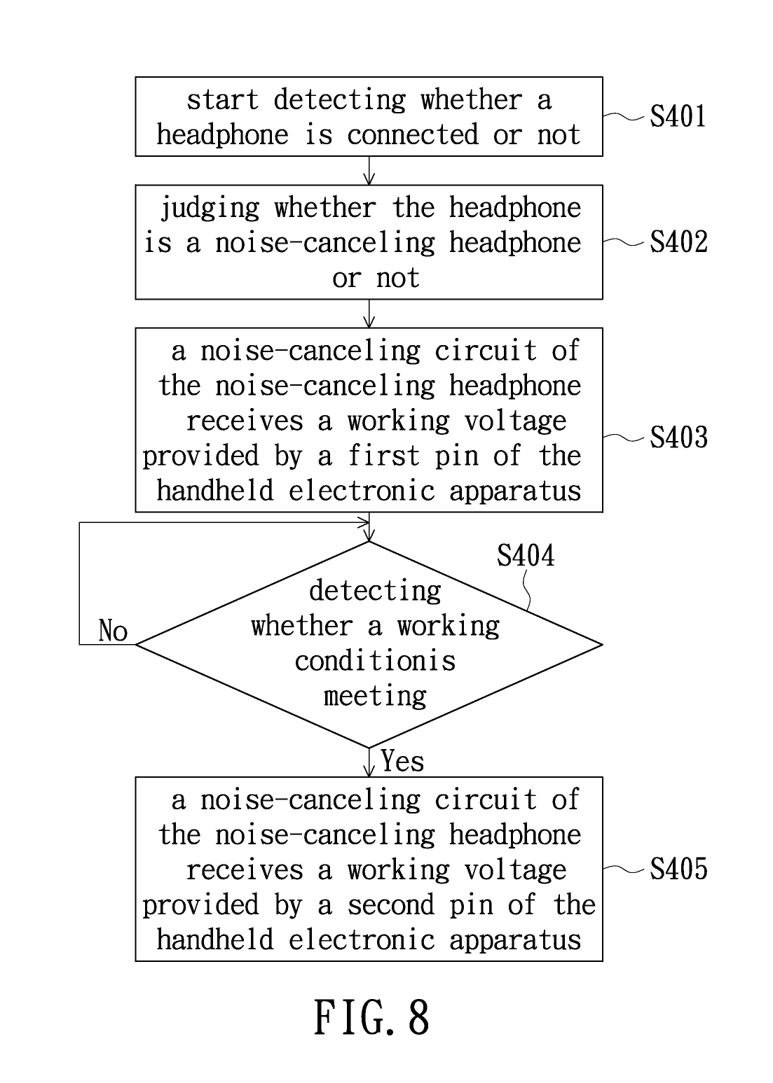

FIG. 8 is a schematic flow diagram illustrating steps of a power management method in accordance with another embodiment of the present invention. The power management method adapted to be applied between the handheld electronic apparatus and a headphone includes steps of: detecting whether a headphone is electrically connected to the handheld electronic apparatus or not (step S401); when the headphone is electrically connected to the handheld electronic apparatus, judging whether the headphone is a noise-canceling headphone or not (step S402); if the headphone is determined as the noise-canceling headphone, then providing a working voltage by the handheld electronic apparatus to a noise-canceling circuit of the noise-canceling headphone through a first pin (step S403); detecting whether a working condition is satisfied or not (step S404); and when the working condition is satisfied, the noise-canceling circuit of the noise-canceling headphone is received the working voltage provided by the handheld electronic apparatus through the second pin.

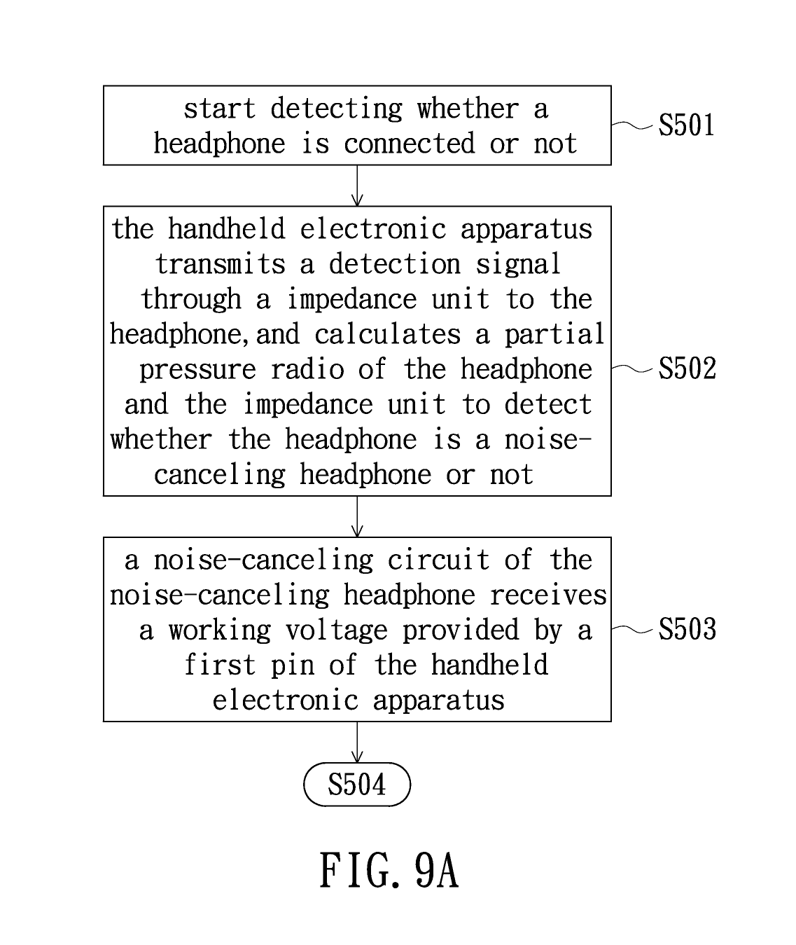

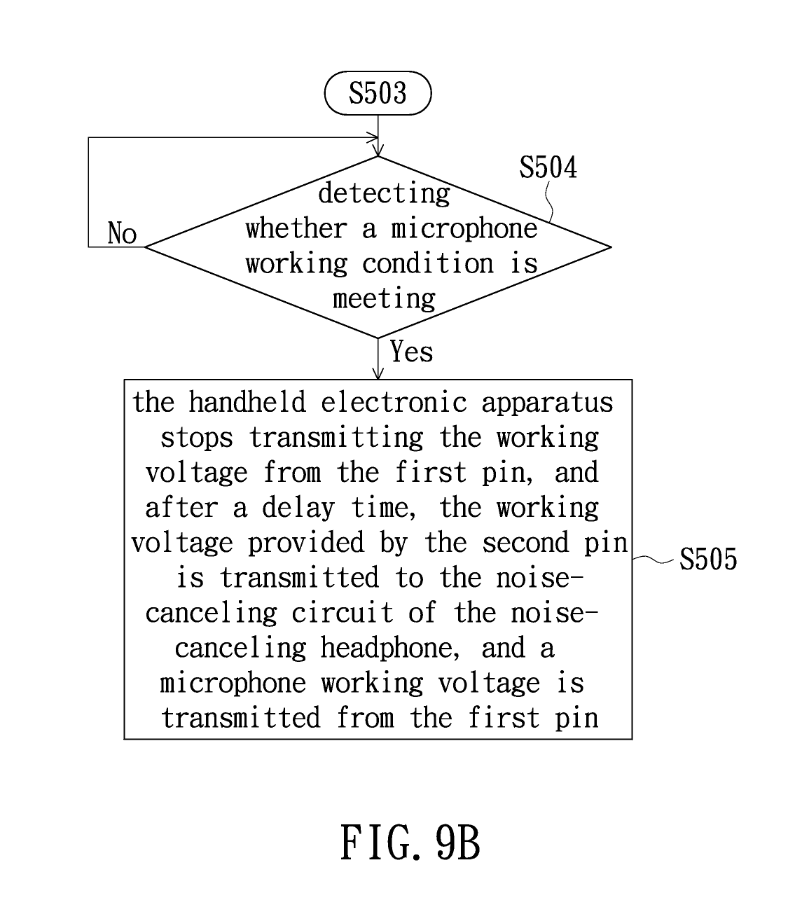

FIG. 9A-9B is a schematic flow diagram illustrating steps of a power management method adapted to be applied between a handheld electronic apparatus and a headphone in accordance with another embodiment of the present invention. The power management method includes steps of: detecting whether the headphone is connected to the handheld electronic apparatus or not (step S501); if the headphone is connected to the handheld electronic apparatus, then transmitting a detecting signal by the handheld electronic apparatus to the headphone through a impedance unit, and measuring a voltage drop radio of the headphone and the impedance unit to judge whether the headphone is a noise-canceling headphone or not (step S502); if the headphone is determined as the noise-canceling headphone, then providing a working voltage by the handheld electronic apparatus to a noise-canceling circuit of the noise-canceling headphone through a first pin (step S503); detecting whether the noise-canceling headphone is in a working condition such as in using a microphone (step S504), and if the noise-canceling headphone is in using the microphone, then stopping transmitting the working voltage from the first pin, and after a delay time, the working voltage provides by the second pin is transmitted to the noise-canceling circuit of the noise-canceling headphone, and a microphone working voltage is transmitted from the first pin (step S505), so as to avoid a power failure situation to generate “POP” sound. Therefore, the “POP” sound may be eliminated by delaying a delay time.

In summary, a plurality of switch circuits disposed in the handheld electronic apparatus and the headphone are provided in the present invention, so as to make the switch circuits control whether the working voltage received by the noise-canceling circuit is transmitted through the microphone line, the left channel line, or the right channel line, and make the headphone function as a noise-canceling headphone.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A handheld electronic apparatus electrically connected to a noise-canceling headphone, comprising:
a connecting interface including a first pin, a second pin and a third pin;
a first switch circuit electrically connected to the first pin;
a second switch circuit electrically connected to the second pin;
a control circuit electrically connected to the connecting interface, the first switch circuit and the second switch circuit, wherein if the control circuit detects that the noise-canceling headphone is electrically connected to the connecting interface, then the first switch circuit is controlled by the control circuit and a working voltage provided by the control circuit is transmitted to a noise-canceling circuit of the noise-canceling headphone through the first switch circuit and the first pin, and if the noise-canceling headphone is in a working condition, the control circuit controls the first switch circuit and the second switch circuit, and the working voltage is transmitted to the noise-canceling circuit of the noise-canceling headphone through the second pin.

2. The handheld electronic apparatus according to claim 1, wherein the working condition is a state that the noise-canceling headphone is in using a microphone, the first switch circuit is suitable for receiving a microphone working voltage provided by the control circuit, and when the noise-canceling headphone is in the working condition, the first switch circuit is controlled by the control circuit to transmit the microphone working voltage instead of the control voltage to the first pin.

3. The handheld electronic apparatus according to claim 1, wherein the second switch circuit is suitable for receiving a left channel signal, and when the noise-canceling headphone is in the working condition, the second switch circuit is controlled by the control circuit to transmit the working voltage instead of the left channel signal to the second pin.

4. The handheld electronic apparatus according to claim 1, wherein when the noise-canceling headphone is in the working condition, the control circuit further comprises controlling the first switch circuit to stop transmitting the working voltage, and after a delay time, then controlling the second switch circuit to start transmitting the working voltage.

5. The handheld electronic apparatus according to claim 1, wherein the third pin electrically connected to the control circuit is suitable for receiving a right channel signal provided by the control circuit, and the control circuit is suitable for sensing whether a headphone is connected to the handheld electronic apparatus in accordance with sensing a voltage change of the third pin, and after determining the headphone is connected to the handheld electronic apparatus, the right channel signal is transmitted to the third pin.

6. The handheld electronic apparatus according to claim 5, wherein the control circuit includes a impedance unit electrically connected to the first switch circuit and the second switch circuit, and if the control circuit determines that the headphone is electrically connected to the connecting interface, then the control circuit outputs a detection signal to the headphone through the impedance unit and the first switch circuit to measure a voltage drop across the headphone and the impedance unit to judge a type of the headphone.

7. The handheld electronic apparatus according to claim 5, wherein the control circuit includes a third switch circuit electrically connected to the first switch circuit, the second switch circuit, and the impedance unit, and if the control circuit determines that the headphone is electrically connected to the connecting interface, the third switch circuit is controlled by the control circuit to transmit the detection signal to the headphone through the impedance unit and the first switch circuit to detect a type of the headphone, and if the control circuit determines that the headphone is the noise-canceling headphone, the third switch circuit is controlled by the control circuit to transmit the working voltage to the noise-canceling circuit.

8. A noise-canceling headphone electrically connected to a handheld electronic apparatus, wherein the handheld electronic apparatus includes a first pin, a second pin, and a third pin, the noise-canceling headphone comprising:
a microphone electrically connected to the first pin;
a left speaker electrically connected to the second pin;
a right speaker electrically connected to the third pin;
a noise-canceling circuit electrically connected to the first pin and the second pin;
a first switch circuit electrically connected between the second pin and the noise-canceling circuit, wherein when the noise-canceling headphone is electrically connected to the handheld electronic apparatus, then a working voltage provided from the first pin is received by the first switch circuit and then transmitted to the noise-canceling circuit; and
a second switch circuit electrically connected between the first pin and the noise-canceling circuit, wherein when the noise-canceling headphone is in using the microphone, then the working voltage provided from the second pin is received by the second switch circuit and then transmitted to the noise-canceling circuit.

9. The noise-canceling headphone according to claim 8, wherein the noise-canceling circuit includes a noise-sensing unit suitable for sensing environment noise.

10. The noise-canceling headphone according to claim 8, further comprising a sensing circuit electrically connected the first pin, the first switch circuit, the second pin, and the second switch circuit, wherein when the noise-canceling headphone is connected to the handheld electronic apparatus, then the sensing circuit senses a voltage of the first pin to determine whether the first switch circuit transmits the working voltage to the noise-canceling circuit; and when the noise-canceling headphone is in using a microphone, then the sensing circuit senses a voltage of the second pin to determine whether the second switch circuit transmits the working voltage to the noise-canceling circuit.

11. The noise-canceling headphone according to claim 8, wherein when the first pin transmits a microphone working voltage instead of the working voltage, then the microphone working voltage is transmitted to the microphone.

12. The noise-canceling headphone according to claim 8, wherein when the second pin transmits a left channel signal instead of the working voltage, then the left channel signal is transmitted to the left speaker by the second switch circuit.

13. The noise-canceling headphone according to claim 12, further comprising a third switch electrically connected to the second pin, the third pin, and the left speaker, wherein when the working voltage provided from the second pin is received by second switch circuit, then the third switch circuit transmits a right channel signal provided from the third pin to the left speaker or the right speaker.
